(19) United States
(12) Patent Application Publication
(10) Pub. No.: US 2025/0100452 A1
(43) Pub. Date: Mar. 27, 2025

(54) HITCH WITH ROTATABLE BALL AND HINGED STEP

(71) Applicant: DYNAMIC MANUFACTURING GROUP LLC, PALMETTO, FL (US)

(72) Inventors: Ronald Lee, JR., Ruskin, FL (US); Anthony Sansone, Parrish, FL (US); Bradly Martin, Sarasota, FL (US)

(21) Appl. No.: 18/474,192

(22) Filed: Sep. 25, 2023

(51) Int. Cl. B60R 3/02; B60D 1/04; B60D 1/60

(52) U.S. Cl. CPC B60R 3/02; B60D 1/04; B60D 1/605

(57) ABSTRACT

A hitch assembly includes a base assembly, a T-shaped mount assembly rotatably mounted to the base, and a step assembly hingedly attached to the base. The base assembly is formed from tabbed and notched sheet metal panels welded together. The mount assembly, which includes one or more coupler engaging devices (e.g., tow balls), rotates about a first axis. The step assembly pivots about a second axis that is orthogonal to the first axis. A bumper disposed between the step assembly and mount assembly reduces vibration of the step, marring of the mount assembly and attendant noise. A spring plunger operable with one hand releasably secures the step in lowered and raised positions. When lowered, the step entirely covers the coupler engaging devices.

### FIELD OF THE INVENTION

This invention relates generally to trailer hitches, and, more particularly, to a hitch system with a body that is formed from tabbed, notched and slotted sheet metal and supports a rotatable mount assembly and hinged step assembly.

### BACKGROUND OF THE INVENTION

Hitches with adjustable ball assemblies are known. Typically, a plurality of towing balls extends perpendicularly from an end of a tube having a square cross section. The available towing ball depends upon the orientation of the tube as it is inserted into a receiver. Selection of a tow ball requires removal of the tube, rotation of the tube until the selected ball is extending upwardly, and reinsertion of the tube in the receiver. Such a process is cumbersome, necessitating handling of a heavy and often grimy object.

Hitches with steps are also known. Some include a fixed step that can be swapped out for a tow ball. Others include a hinged step that can be pivoted out of the way to reveal a tow ball. In some cases, pivoting the step to a raised position is cumbersome, possibly even requiring tools. In other cases, the step may be insecure in the raised position. In many such configurations the step rests upon the ball or mount assembly, when the step is in position for use. Such contact creates rattling noise as the vehicle travels. Such contact also mars the finish of the mount assembly.

Hitches with a hinged step and one tow ball or a plurality of tow balls require a structure to which the mount assembly and step attaches. Such attachment structures are typically bulky and inefficient to produce.

A trailer hitch with a cost-effective attachment structure, an easy to rotate mount assembly; an easy to raise, lower and secure step; and protection from rattling, wobbling and marring is needed.

The invention is directed to overcoming one or more of the problems and solving one or more of the needs as set forth above.

### SUMMARY OF THE INVENTION

To solve one or more of the problems set forth above, in an exemplary implementation of the invention, a hitch assembly includes a base assembly, a mount assembly rotatably coupled to the base assembly, and a step assembly hingedly attached to the base assembly. The mount assembly is rotatable from a mount stored position to a mount deployed position. A portion of the mount assembly extends from the base and includes at least one coupler engagement device (such as, but not limited to a tow ball. In the mount deployed position a coupler engagement device extends upward. In the mount stored position the coupler engagement device does not extend upward. Thus, in the mount stored position, the coupler engagement device does not impede deployment of the step assembly. The step assembly is pivotable from a step deployed position to a step raised position. In the step deployed position, the step assembly covers (overlays, in a plan view) the portion of the mount assembly extending from the base and, in a plan view, no portion of the at least one coupler engagement device extends beyond the step.

The base assembly may be formed from a plurality of sheet metal panels defining an interior space, with a front side, a back side, a right side and a left side. The plurality of sheet metal panels may be joined to define the interior space using notch and tab welded construction.

The step assembly includes a step having a back side and a pair of hinge brackets attached to the back side of the step. The pair of hinge brackets include a right hinge bracket and a left hinge bracket. The right hinge bracket is pivotally coupled to the right side of the base assembly. The left hinge bracket is pivotally coupled to the left side of the base assembly. A pivot pin extends through the right hinge bracket, right side of the base assembly, left side of the base assembly and left hinge bracket. The step assembly is pivotable about the pivot pin.

The step may be formed of a sheet metal panel (i.e., a single sheet) cut and bent to form a top side, a first flange forming the back side of the step, a second flange forming a left side of the step, a third flange forming a right side of the step and a fourth flange comprising a front side of the step.

The left side of the base assembly includes at least three holes, including a pivot pin hole through which the pivot pin extends, and two plunger holes along an arc having a center at the pivot pin hole. The two plunger holes are at least about 90 degrees apart and include a first plunger hole and a second plunger hole. The left hinge bracket includes at least two holes, including a pivot pin hole through which the pivot pin extends, and a spring plunger hole. The spring plunger hole aligns with the first plunger hole when the step assembly is in the step deployed position. The spring plunger hole aligns with the second plunger hole when the step assembly is in the step raised position. A spring plunger may be attached to the left hinge bracket at the spring plunger hole and configured to project a plunger into the first plunger hole when the step assembly is in the step deployed position and into the second plunger hole when the step assembly is in the step raised position.

Additionally, or in the alternative, the right side of the base assembly includes at least three holes, including a pivot pin hole through which the pivot pin extends, and two plunger holes along an arc having a center at the pivot pin hole. The two plunger holes are at least about 90 degrees apart and include a first plunger hole and a second plunger hole. The right hinge bracket includes at least two holes, including a pivot pin hole through which the pivot pin extends, and a spring plunger hole. The spring plunger hole aligns with the first plunger hole when the step assembly is in the step deployed position. The spring plunger hole aligns with the second plunger hole when the step assembly is in the step raised position. A spring plunger may be attached to the right hinge bracket at the spring plunger hole and configured to project a plunger into the first plunger hole when the step assembly is in the step deployed position and into the second plunger hole when the step assembly is in the step raised position. Thus, the hitch assembly may include a right-side spring plunger, a left side spring plunger or both right and left side spring plungers.

The spring plunger includes a knob, a hollow body, a groove at an end of the hollow body facing the knob, and a plug on a side of the knob facing the groove. The plug is configured to mate with the groove when the plug is aligned with the groove and the knob is not moved away from the hollow body. A shaft is attached to the knob and extends into the hollow body. The knob is movable away from and towards the hollow body. The knob is also rotatable to align the plug and groove and to move the plug out of alignment with the groove.

The base assembly includes a front side opening and a back side opening. The mount assembly includes a shank (e.g., cylindrical shaft). The shank extends through the front side opening and back side opening. The shank is rotatable relative to the base assembly.

The mount assembly includes a shoulder coupled to the shank. The shoulder is the portion of the mount assembly to which coupler engaging devices are attached, permanently attached (i.e., fixed) or removably attached. At least one coupler engaging device (e.g., one or more tow balls) is attached to the shoulder. For example, a pair of tow balls may be attached. One tow ball may be attached to a first end of the shoulder. Another tow ball may be attached to a second end of the shoulder opposite the first end. An axis extending through the first end and the second end is orthogonal to the shank. In the mount stored position the neither tow ball extends upward. Rather, they are aligned, with each tow ball and the shank bisected (conceptually divided into two parts) by a plane (e.g., a horizontal plane).

A compressible bumper attached to the underside of the top panel of the step assembly. The compressible bumper contacts the mount assembly when the step assembly is in the step deployed (lowered) position, e.g., when the top panel of the step is in a position suitable for use as a step, such as when the top panel is horizontal or substantially horizontal. The compressible bumper may be comprised of a resilient elastomer. The compressible bumper may have an uncompressed height that is greater than the distance between the underside of the top panel and the mount assembly when the step assembly is in the step deployed position. In this manner, the compressible bumper is compressed when the step assembly is in the step deployed position.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a perspective view of an exemplary hitch with a step in a lowered position in accordance with principles of the invention.

FIG. 2 is a perspective view of an exemplary hitch with a step in a raised position in accordance with principles of the invention.

FIG. 3 is a first perspective view of an exemplary hitch with a step in a raised position and a tow ball rotated to a vertical upward orientation in accordance with principles of the invention.

FIG. 4 is a second perspective view of an exemplary hitch with a step in a raised position and a tow ball rotated to a vertical upward orientation in accordance with principles of the invention.

FIG. 5 is a perspective exploded view of the base assembly and mount assembly for a hitch in accordance with principles of the invention.

FIG. 6 is a perspective exploded view of an exemplary step assembly and base assembly for a hitch in accordance with principles of the invention.

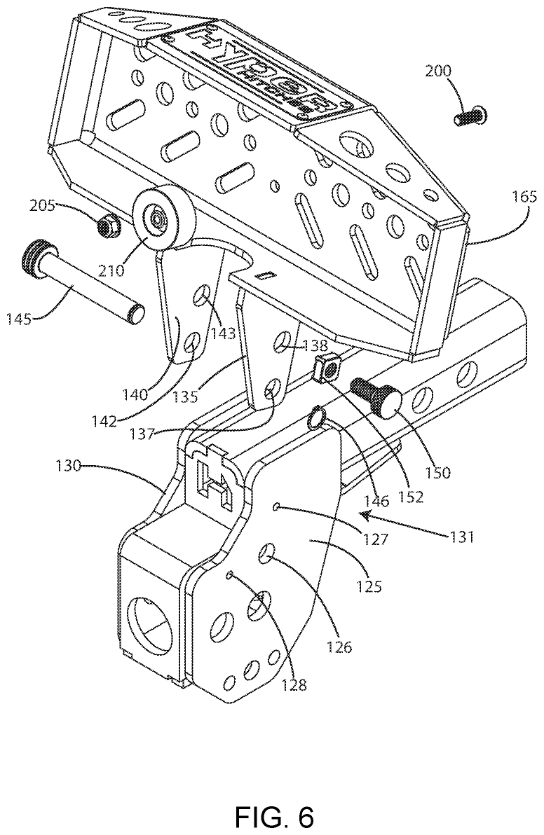

FIGS. 7A-7D provide views of an exemplary spring plunger with the plunger in an extended state and in a retracted state for a hitch in accordance with principles of the invention.

FIG. 8 is a perspective view of an exemplary base assembly for a hitch in accordance with principles of the invention.

FIG. 9 is a perspective exploded view of another exemplary base assembly for a hitch in accordance with principles of the invention.

FIG. 10 is a perspective exploded view of an exemplary mount assembly with removable tow balls for a hitch in accordance with principles of the invention.

FIG. 11 is a plan view of an exemplary hitch with a step in a lowered (deployed) position in accordance with principles of the invention.

The figures are not intended to be drawn to any particular scale. The figures are not intended to illustrate every embodiment of the invention. The invention is not limited to the exemplary embodiments depicted in the figures or to the specific components, configurations, shapes, relative sizes, ornamental aspects or proportions as shown in the figures.

### DETAILED DESCRIPTION

A hitch according to principles of the invention includes a base assembly, a mount assembly rotatably mounted to the base, and a step assembly hingedly attached to the base. The mount assembly rotates about a first axis. The step assembly pivots about a second axis that is orthogonal to the first axis. A bumper disposed between the step assembly and mount assembly reduces vibration of the step, marring of the mount assembly and attendant noise. A spring plunger that may be operated with one hand releasably secures the step in lowered and raised positions.

The base assembly is a strong relatively lightweight framework of tabbed, notched and slotted metal components. Welding is performed primarily in areas of the tab, slot and notched joints. The thickness of usable plates is limited, in particular, by the production limits of the laser, water or plasma cutting machinery in relation to the selected material. Advantages of such a base assembly are easy application of relief, while maintaining a high frame rigidity and stability, at lower cost and weight than conventional assembly of milled billets or cast housings welded to tubes. Another advantage is shape precision of the resulting welded structure where, unlike the application of continuous or intermittent fillet welds, there is no thermal deformation of the frame. By grinding the area of the welds, it is possible to achieve an aesthetically interesting frame without any visible connection.

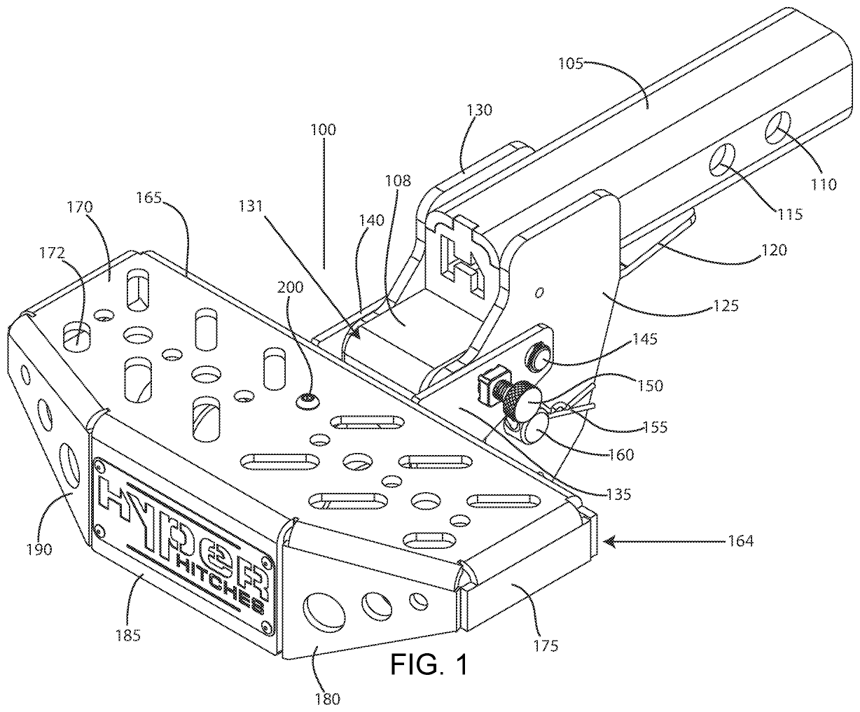

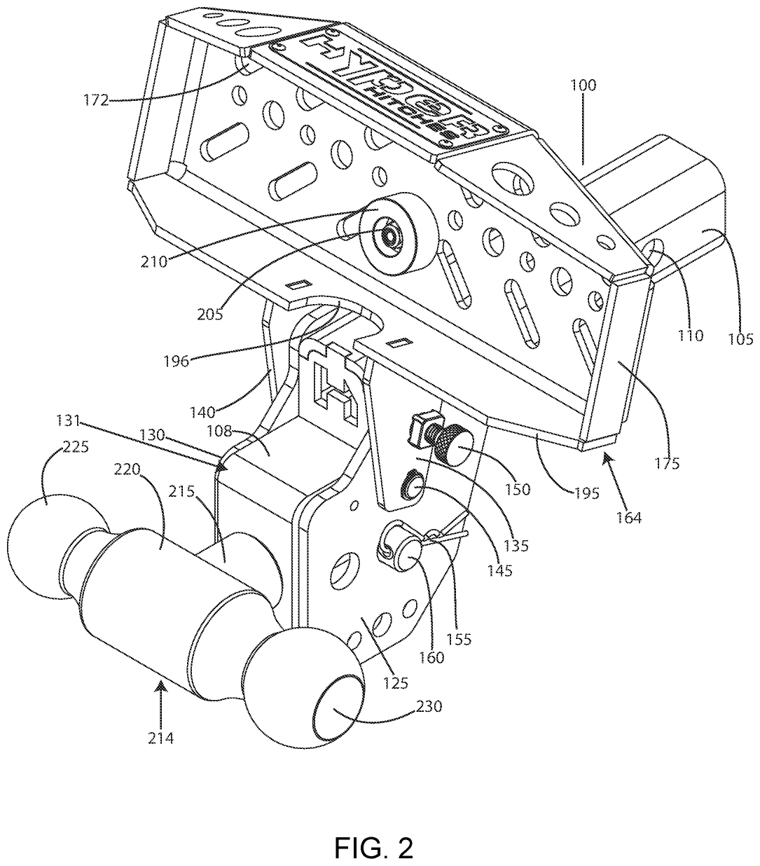

FIG. 1 provides a perspective view of an exemplary hitch 100 with a step 165 in a lowered position in accordance with principles of the invention. A step assembly 164 is hingedly attached to a base assembly 131. A hitch mount tube 105 is attached to the base assembly 131, opposite the step assembly 164. A mount assembly 214 is rotatably mounted to the base assembly 131, as shown in FIG. 2.

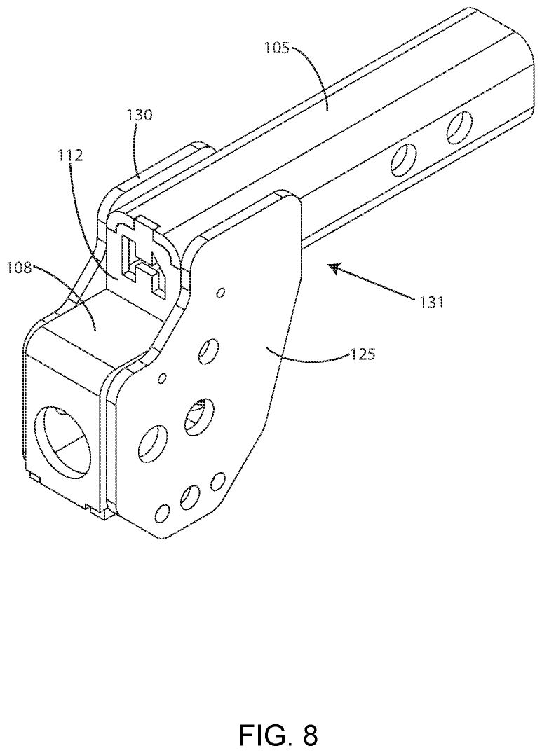

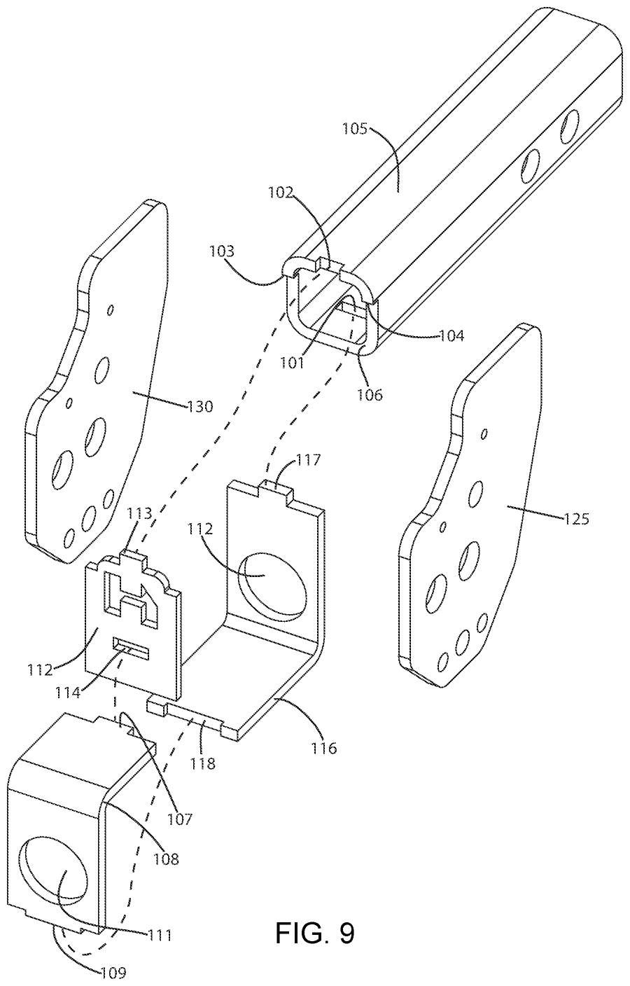

With reference to FIGS. 8 and 9, the base assembly 131 is comprised of a front bracket 108, a rear bracket 116, side panels 125, 130, and a tube cover 112. The components include tabs and notches to facilitate construction via welding. Tabs are inserted into notches or slots as conceptually indicated by dotted lines in FIG. 9.

The front 106 of the hitch mount tube 105 includes shoulders 103, 104 flanking a notch 102. Thus, the notch 102 is disposed between the shoulders 103, 140. The tube cover 112 is configured (shaped and sized) to mate with the front 106 of the hitch mount tube 105. Tab 113 of the tube cover 112 fits into the notch 102 at the front 106 of the hitch mount tube 105. The tube cover 112 also includes a slot 114 configured for mating engagement with the tab 107 of front bracket 108. The hitch mount tube 105 includes a slot 101 configured for mating engagement with tab 117 of rear bracket 116.

Front bracket 108 is an angle bracket, with two panel sections in perpendicular planes that intersect at a corner. One panel section includes a tab 107 configured for mating engagement with slot 114 in tube cover 112. The other panel section includes a tab 109 configured for mating engagement with notch 118 of rear bracket 116. One panel also includes a hole 111 for receiving a shank of the rotatable mount assembly.

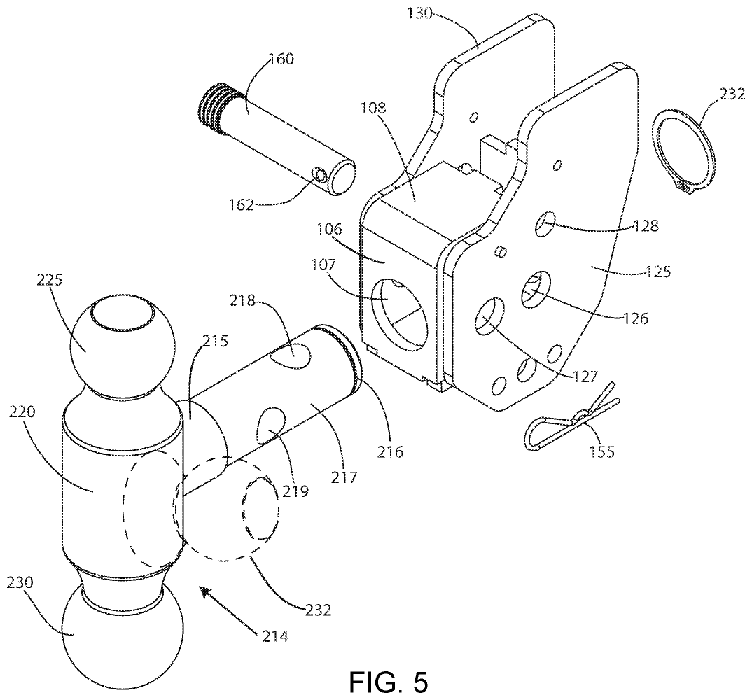

Rear bracket 116 is an angle bracket, with two panel sections in perpendicular planes that intersect at a corner. One panel section includes a tab 117 configured for mating engagement with slot 101 in the hitch mount tube 105. The other panel section includes a notch 118 configured for mating engagement with tab 109 of front bracket 108. One panel also includes a hole 112 for receiving a shank 217 (FIG. 5) of the rotatable mount assembly 214.

Hole 112 aligns with hole 111, when the base assembly 131 is constructed. The holes are coaxial, having a coincident central axes or a central axis that may extend through the center of hole 111 and through the center of hole 112. The holes 111, 112 are also the same diameter.

The base assembly 131 is attached to a hitch mount tube 105. The hitch mount tube 105 is sized and shaped to be received in a receiver mounted to a vehicle. The exemplary hitch mount tube 105 is hollow. However, a solid bar may be used in lieu of a hollow tube, without departing from the scope of the invention. As used herein, hitch mount tube, mount tube and the like are intended to mean both hollow and solid elongated structures configured (sized and shaped) to securely fit into a receiver of a trailer hitch.

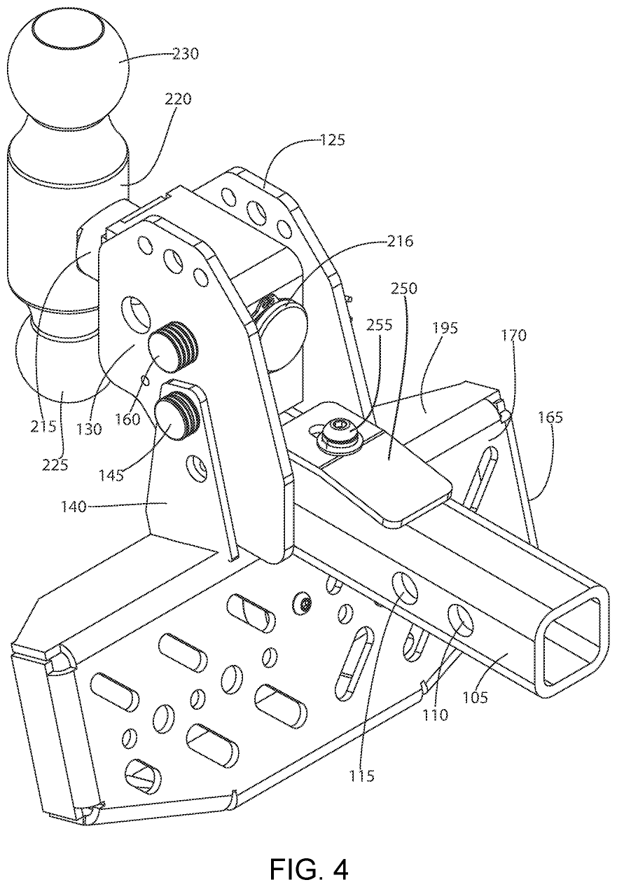

As shown in FIG. 4, the bottom of the hitch mount tube 105 includes a clamp 250, secured by a screw 255. The clamp 250 securely grips the outer edge (usually a thickened outer edge) of a receiver, when either one of the hitch pin holes 110, 115 aligns with a hitch pin hole in the receiver. The clamp 250 stabilizes the hitch mount tube, reducing the risk of wobbling step 165.

Side panel 125 is identical to side panel 130. The widths of the brackets 108, 116, tube cover 112 and tube 105 are approximately equal. Thus, side panels 125, 130 are generally parallel when attached (e.g., welded) to opposite side edges of the brackets 108, 116, and tube cover 112, and to opposite sides of the tube 105. When constructed, the front edges of the panels 125, 130 are substantially flush and coextensive with the front face of the front bracket 108 as shown in FIG. 8. Holes 126, 127, 128 (FIG. 5) of side panel 125 align with the equivalent holes of side panel 130 when the panels 125, 130 are welded in place. An axis extending through the center of hole 126 and the equivalent hole in panel 130, and an axis extending through the center of hole 127 and the equivalent hole in panel 130, and an axis extending through the center of hole 128 and the equivalent hole in panel 130 are perpendicular to each other. The constructed base assembly 131 with the hitch mount tube 105 loosely resembles a pistol, as shown in FIG. 8.

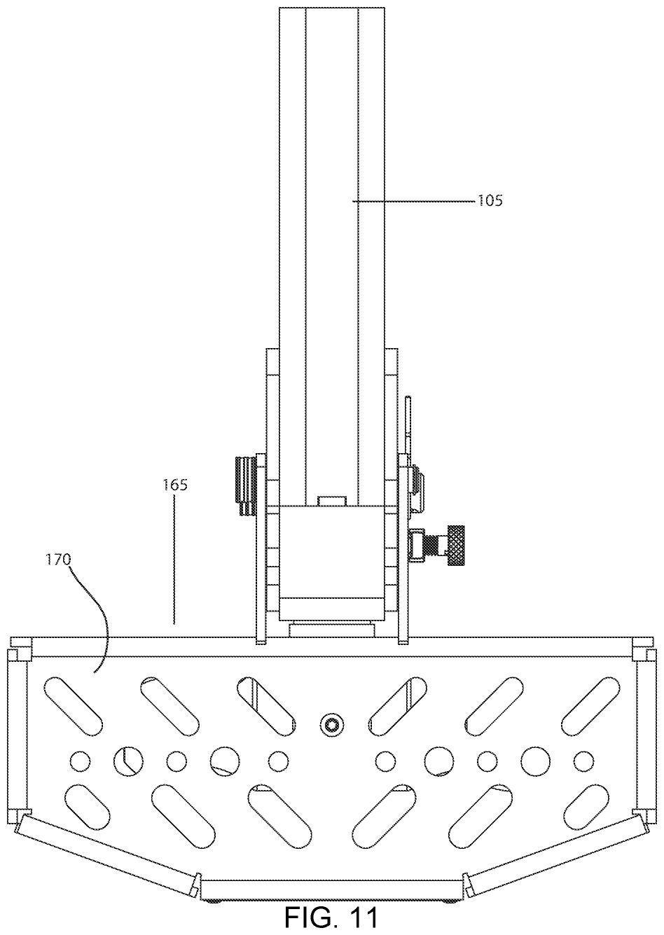

Referring to FIGS. 1 and 2, the step assembly includes hinge brackets 135, 140, a hinge pin 145, a spring plunger 150 and a step 165. The top surface of the step is sufficiently large to cover the entire mount assembly 214. The width of the step 165 measured from left side to right side is greater than the maximum width of the mount assembly 214 (e.g., from tow ball to tow ball). The depth of the step 165 measured from front to back is greater than the depth of the portion of the mount assembly 214 extending from the base assembly 131. The step 165 includes perforations 172 through which water, dirt and other debris may fall. The perforations 172 also enhance grip. When the step 165 is in the deployed position as shown in FIG. 1, the top panel 170 (top surface) of the step 165 and the top surface of the hitch mount tube 105 are generally (i.e., approximately) in parallel planes. In the deployed position, the top panel 170 of the step 165 is in a position suitable for use as a stepping surface, such as when the top panel 170 is horizontal or substantially horizontal. As shown in FIG. 11, in the deployed position, the step 165 (i.e., the top panel 170) covers (overlays, in a plan view) the portion of the mount assembly 214 extending from the base and no portion of any coupler engagement device (e.g., any tow ball) of the mount assembly 214 extends beyond the step 165. If the top surface of the hitch mount tube is horizontal, then the top panel 170 of the step 165 is approximately horizontal. Some deviation from parallel is possible depending upon conditions of use, such as applying extreme weight, particularly to one side of the step 165.

In the exemplary embodiment, the step 165 is formed from a metal sheet that is cut and folded (bent) into a shape of a pentagonal box with an open bottom. Sides (flanges) 175, 180, 185, 190 and 195 extend downward from bends at the edges of the top panel 170. A semicircular shaped cutout 196 is formed in the rear downward side 196 of the step 165 to at least partially receive the neck 215 of the mount assembly 214, when the step is in the deployed position as shown in FIG. 1. Hinge brackets 135, 140 are fixed (e.g., welded) to the rear downward side 196 of the step 165, with bracket 135 being aligned with and parallel to bracket 140. Edges between adjacent sides may be joined (e.g., welded) together to form a stable rigid structure.

The brackets 135, 140 are identical. Each bracket includes a hinge pin hole 137, 142. Each bracket also includes a spring plunger hole 138, 143. However, only one spring plunger hole (e.g., hole 138) is needed if one spring plunger 150 is used. If a spring plunger is provided for each hinge bracket 135, 140, both holes 138, 143 may be used. The hinge pin holes 137, 142, align with holes 126 in the side panels 125, 130. A central axis extends through the center of hinge pin holes 137, 142, align with holes 126 in the side panels 125, 130. The holes 137, 142 and 126 in the side panels 125, 130 are coaxial. The holes 137, 142 and 126 in the side panels 125, 130 have equivalent diameters. A shank of a hinge pin 145 extends through the holes 137, 142 and 126 in the side panels 125, 130 to provide a pivot. The hinge pin 145 is secured in the holes 137, 142 and 126, with an external retaining ring 146 that engages an annular groove at the end of the hinge pin 145. The hinge brackets 135, 140 and attached step 165 pivot, relative to the side panels 125, 130, about the hinge pin 145 from a deployed position as shown in FIG. 1 to a raised position as shown in FIG. 2.

A bumper 210 is attached to the underside of the top 170 of the step 165. The bumper 210 may be attached with a screw 200 and nut 205, other mechanical fasteners and/or adhesives. When the step 165 is in the deployed position as shown in FIG. 1, the bumper 210 is disposed between (i.e., sandwiched between) the underside of the top 170 of the step 165 and the shoulder 220 of the mount assembly 214. The exemplary bumper 210 is a resilient ring-shaped structure (e.g., a resilient elastomeric structure) that compresses when a compressive force is applied. Shapes other than ring-shaped (e.g., cylindrical, hemispherical, etc. . . . ) may be used without departing from the scope of the invention. Nonlimiting examples of suitable elastomers include butadiene rubber, butyl rubber, nitrile rubber styrene-butadiene rubber, polyurethane rubber, and silicone rubber. The bumper 210 dampens vibrations, absorbs shocks, and mitigates rattling and wobbling of the step 165 and marring of the finish on the underside of the step 165 and the portions of the mount assembly 214 facing the step 165 when the step 165 is deployed. The bumper 210 is sized to be slightly taller than the distance between the underside of the top 170 of the step 165 and the shoulder 220 of the mount assembly 214 to serve as a cushion and vibration dampener when the step 165 is locked in the down (deployed) position. In a preferred implementation, the bumper is compressed (e.g., slightly compressed) when the step 165 is locked in the down (deployed) position. By way of example and not limitation, a bumper height that is 1 mm to 10 mm, or 1 mm to 5 mm, greater than the distance between the underside of the top 170 of the step 165 and the shoulder 220 of the mount assembly 214 may be used. A bumper with a smaller height may be used, but will be less effective or ineffective in damping vibration.

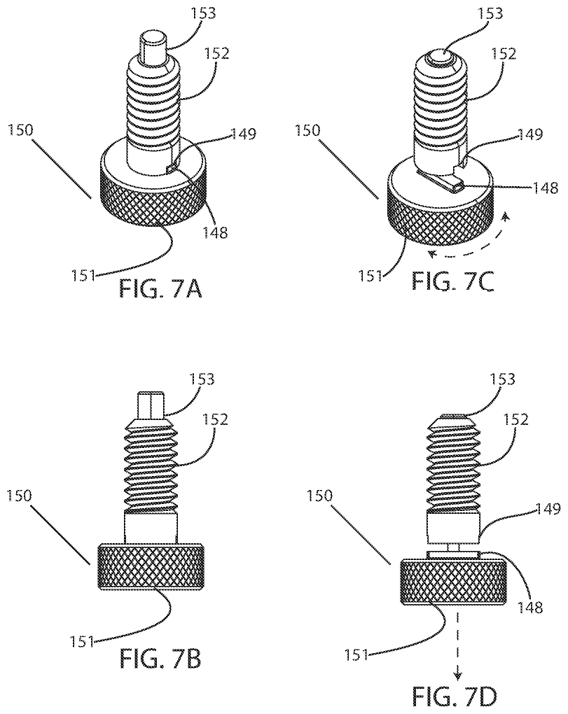

At least one spring plunger 150 is provided to releasably lock the step 165 in a deployed position as shown in FIG. 1 and a raised position as shown in FIG. 2. With reference to FIGS. 7A-7D, the spring plunger includes a knurled knob 151, a hollow body 152 with external threads, a groove 149 at one end of the body, a plug 148 attached to side of the knurled knob 151 facing the groove 149, a shaft with a spring biased pin 153 extending from the end of the hollow body 152 and movable from an extended position as shown in FIGS. 7A and 7B to a retracted position as shown in FIGS. 7C and 7D. Retraction of the pin 153 is achieved by pulling the knurled knob 151 away from the hollow body 152. When the knurled knob 151 is pulled away from the hollow body 152, the knurled knob 151 may be rotated until the plug 148 is not in alignment with the groove 149. Then the knob 151 may be released without the pin 153 returning to the fully extended position. To restore the pin 153 to the fully extended position, the knurled knob 151 may be rotated until the plug 148 aligns with the groove 149 and then the knob 151 may be released. The internal spring biasing force will urge the pin 153 to the extended position as shown in FIGS. 7A and 7B, and the knurled knob 151 will abut the hollow body 152.

The spring plunger 150 is aligned with a hole 138 in the hinge bracket 135. In the exemplary embodiment, a nut 152 is fixed (e.g., welded) to the hinge bracket 135 over the hole 138. Threads of the externally threaded hollow body 152 are threadedly received in the nut 152. When the pin 153 is retracted, the pin does not extend appreciably past the hole 138 in the hinge bracket 135. When the pin 153 is extended, it may extend into pin hole 128 or pin hole 127 in the side plate 125. Extension of the pin 153 into pin hole 128 may occur when the step 165 is pivoted to a deployed position. In the deployed position, the spring plunger hole 138 aligns with pin hole 128. Extension of the pin 153 into pin hole 127 may occur when the step 165 is pivoted to a raised position. In the raised position, the spring plunger hole 138 aligns with pin hole 127. Through pivoting motion of the step 165 and its attached hinge brackets 135, 140, the spring plunger hole 138 moves in an arc path to and between positions aligned with pin holes 127, 128. The arc path has a center at pivot pin hole 126. The arc angle is preferably at least about 90 degrees (e.g., 80 to 110 degrees).

Advantageously, the spring plunger 150 may be operated with one hand. By pulling the knob 151 and rotating the pulled knob 151, the pin 153 may be locked in a retracted position. By pulling the knob 151 and rotating the pulled knob 151 until the plug 148 aligns with the groove 149, the pin 153 may be released to an extended position into one of the pin holes 127, 128.

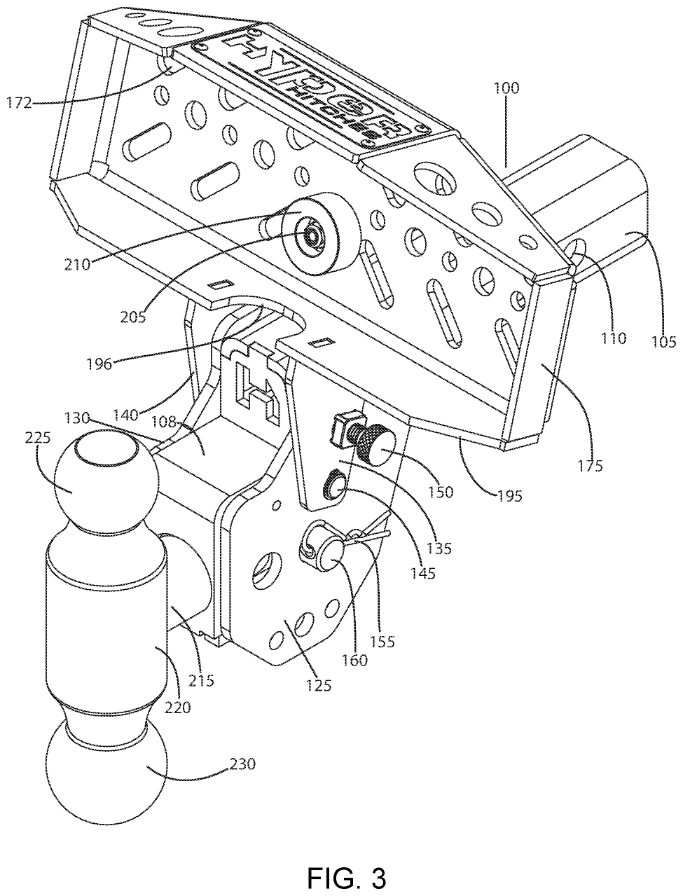

FIGS. 2-4 provide perspective views of the exemplary hitch 100 with the step 165 in a raised position. In FIG. 2 the tow mount assembly 214 is in a stored position. The exemplary tow mount assembly 214 is generally T-shaped. In FIGS. 3 and 4 the mount assembly 214 has been rotated + or −90 degrees from the stored position to a deployed position. Upon such rotation, a tow ball 225 extends upward, while another tow ball 230 extends downward. There are four standard tow ball sizes: 1⅞″, 2″, 2 5/16″ and 3″. One tow ball may be one size while the other tow ball may be another size. In an alternative embodiment, as conceptually illustrated by broken lines in FIG. 5, a third tow ball 232 of yet another size may also be provided on the tow mount assembly 214.

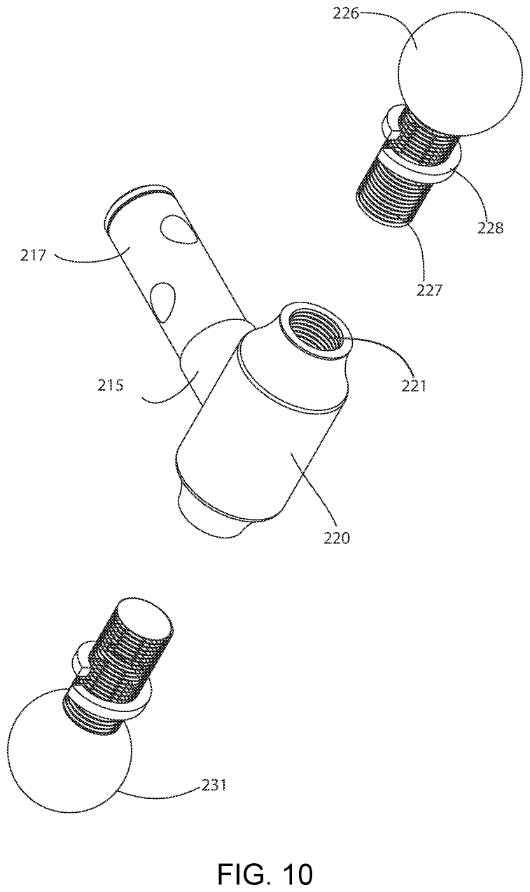

The invention is not limited to a mount assembly equipped with tow balls. Other towing devices may be included in lieu of one or more tow balls. Such other devices may include a hook, a shackle, a lunette hook, etc. Additionally, the invention is not limited to tow devices such as tow balls that are permanently fixed to the shoulder 220. For example, with reference to FIG. 10, the shoulder 220 may include one or more internally threaded channels, such as channel 221, configured to receive a threaded shaft 227 of a mount device, such as, but not limited to, a tow ball 226, 231. A lock washer 228 may be used to enhance frictional engagement and reduce risk of loosening.

The tow mount assembly 214 includes a cylindrical shank 217; an end with an annular groove 216; a neck 215 that may have a greater diameter than the shank 217 and does not have to be cylindrical; a shoulder 220 from which tow balls 225, 230 and optionally 232 extend; and an external retainer 232 for engaging the annular groove 216 when the shank 217 extends through the holes 107, 108. A pair of offset pin retaining holes 218, 219 are provided in the shank 217. The pin retaining holes 218, 219 may be rotated into alignment with holes 126, 127 in the side panels 125, 130 when the shank 217 extends through the holes 107, 108. In the stored position, pin retaining hole 218 aligns with holes 126 in the side panels 125, 130. In the deployed position, with either ball 225 or ball 230 extending upward, pin retaining hole 219 aligns with holes 127 in the side panels 125, 130. The retaining pin 160 may be inserted through whichever side panel holes 126, 127 are in alignment with pin retaining holes 218, 219 in the shank 217. A straight arm of a cotter pin 155 may be inserted through a hole 162 in the end of the retaining pin 160 to releasably lock the retaining pin 160 in place.

Any dimensions are provided as approximate dimensions for an embodiment. Dimensions may be varied without departing from the scope of the invention. Varied dimensions that do not substantially impair utility of the invention come within the spirit and scope of the invention. Subject to the foregoing, unless otherwise specified herein, any claimed dimensions may be varied by at least ±5% without departing from the scope of the invention.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A hitch assembly comprising:
a base assembly, a mount assembly rotatably coupled to the base assembly, and a step assembly hingedly attached to the base assembly;
the mount assembly being rotatable from a mount stored position to a mount deployed position, a portion of the mount assembly extending from the base and including at least one coupler engagement device, and in the mount deployed position a coupler engagement device extending upward, and in the mount stored position the coupler engagement device not extending upward; and
the step assembly being pivotable from a step deployed position to a step raised position, and in the step deployed position, the step assembly covering the portion of the mount assembly extending from the base.

2. The hitch assembly of claim 1, the base assembly comprising a plurality of sheet metal panels defining an interior space, and including a front side, a back side, a right side and a left side.

3. The hitch assembly of claim 2, the plurality of sheet metal panels joined to define the interior space using notch and tab welded construction.

4. The hitch assembly of claim 1, the base assembly having a left side and a right side, the step assembly including a step, the step having a back side and a pair of hinge brackets attached to the back side of the step, the pair of hinge brackets including a right hinge bracket and a left hinge bracket, and the right hinge bracket of the pair of hinge brackets being pivotally coupled to the right side of the base assembly, and the left hinge bracket of the pair of hinge brackets being pivotally coupled to the left side of the base assembly.

5. The hitch assembly of claim 4, the step comprising a sheet metal panel cut and bent to form a top side, a first flange forming the back side of the step, a second flange forming a left side of the step, a third flange forming a right side of the step and a fourth flange comprising a front side of the step.

6. The hitch assembly of claim 4, further comprising a pivot pin extending through the right hinge bracket, right side of the base assembly, left side of the base assembly and left hinge bracket, and the step assembly being pivotable about the pivot pin.

7. The hitch assembly of claim 6, the left side of the base assembly including at least three holes, including a pivot pin hole through which the pivot pin extends, and two plunger holes along an arc having a center at the pivot pin hole, the two plunger holes being at least about 90 degrees apart and including a first plunger hole and a second plunger hole; and
the left hinge bracket including at least two holes, including a pivot pin hole through which the pivot pin extends, and a spring plunger hole, the spring plunger hole aligning with the first plunger hole when the step assembly is in the step deployed position, and the spring plunger hole aligning with the second plunger hole when the step assembly is in the step raised position; and
a spring plunger attached to the left hinge bracket at the spring plunger hole and configured to project a plunger into the first plunger hole when the step assembly is in the step deployed position and into the second plunger hole when the step assembly is in the step raised position.

8. The hitch assembly of claim 7, the spring plunger comprising a knob, a hollow body, a groove at an end of the hollow body facing the knob, a plug on a side of the knob facing the groove, the plug being configured to mate with the groove when the plug is aligned with the groove and the knob is not moved away from the hollow body, a shaft attached to the knob and extending into the hollow body, and the knob being movable away from and towards the hollow body, and the knob being rotatable to align the plug and groove and move the plug out of alignment with the groove.

9. The hitch assembly of claim 6, the right side of the base assembly including at least three holes, including a pivot pin hole through which the pivot pin extends, and two plunger holes along an arc having a center at the pivot pin hole, the two plunger holes being at least about 90 degrees apart and including a first plunger hole and a second plunger hole; and
the right hinge bracket including at least two holes, including a pivot pin hole through which the pivot pin extends, and a spring plunger hole, the spring plunger hole aligning with the first plunger hole when the step assembly is in the step deployed position, and the spring plunger hole aligning with the second plunger hole when the step assembly is in the step raised position; and
a spring plunger attached to the right hinge bracket at the spring plunger hole and configured to project a plunger into the first plunger hole when the step assembly is in the step deployed position and into the second plunger hole when the step assembly is in the step raised position.

10. The hitch assembly of claim 9, the spring plunger comprising a knob, a hollow body, a groove at an end of the hollow body facing the knob, a plug on a side of the knob facing the groove, the plug being configured to mate with the groove when the plug is aligned with the groove and the knob is not moved away from the hollow body, a shaft attached to the knob and extending into the hollow body, and the knob being movable away from and towards the hollow body, and the knob being rotatable to align the plug and groove and move the plug out of alignment with the groove.

11. The hitch assembly of claim 1, the base assembly including a front side and a back side, and a front side opening in the front side of the base assembly, and a back side opening in the back side of the base assembly; and
the mount assembly including a shank, the shank extending through the front side opening in the front side of the base assembly, and through back side opening in the back side of the base assembly, and the shank being rotatable relative to the base assembly.

12. The hitch assembly of claim 11, the mount assembly including a shoulder coupled to the shank of the mount assembly adjacent to the front side of the base assembly, and the at least one coupler engaging device attached to the shoulder.

13. The hitch assembly of claim 12, the at least one coupler engaging device comprising at least one tow ball.

14. The hitch assembly of claim 12, the at least one coupler engaging device being removably attached to the shoulder.

15. The hitch assembly of claim 12, the shoulder having a first end and a second end opposite the first end, and an axis extending through the first end and the second end being orthogonal to the shank, and the at least one coupler engaging device comprising at least a pair of tow balls including a first tow ball attached at the first end and a second tow ball attached at the second end, and in the mount deployed position a coupler engagement device extending upward, and in the mount stored position the first tow ball and the second tow ball not extending upward.

16. The hitch assembly of claim 15, in the mount stored position the first tow ball and the second tow ball being aligned, with a plane bisecting each of the first tow ball and the second tow ball and the shank.

17. The hitch assembly of claim 1, the step assembly including a step, the step including a top panel having a support side and an underside opposite the support side, and the hitch assembly including a compressible bumper attached to the underside of the top panel, the compressible bumper contacting the mount assembly when the step assembly is in the step deployed position.

18. The hitch assembly of claim 17, the compressible bumper being comprised of a resilient elastomer.

19. The hitch assembly of claim 17, the compressible bumper having an uncompressed height that is greater than the distance between the underside of the top panel and the mount assembly when the step assembly is in the step deployed position.

20. The hitch assembly of claim 19, the compressible bumper being compressed when the step assembly is in the step deployed position.
